(19) United States
(12) Patent Application Publication
(10) Pub. No.: US 2011/0056457 A1
(43) Pub. Date: Mar. 10, 2011

(54) SYSTEM AND APPARATUS FOR CONDENSATION OF LIQUID FROM GAS AND METHOD OF COLLECTION OF LIQUID

(75) Inventors: David Livshits, San Francisco, CA (US); Lester Teichner, Chicago, IL (US)

(73) Assignee: TURBULENT ENERGY, INC., Lexington, MA (US)

(21) Appl. No.: 12/990,942

(22) PCT Filed: May 12, 2009
(86) PCT No.: PCT/US09/43547

§ 371 Date: Nov. 3, 2010

Related U.S. Application Data
(60) Provisional application No. 61/052,317, filed on May 12, 2008.

(51) Int. Cl. F02B 47/02; F25J 3/06

(52) U.S. Cl. 123/25 R; 62/401; 62/90

(57) ABSTRACT

The present disclosure generally relates to an apparatus for the condensation of a liquid suspended in a gas, and more specifically, to an apparatus for the condensation of water from air with a geometry designed to emphasize adiabatic condensation of water using either the Joule-Thompson effect or the Ranque-Hilsch vortex tube effect or a combination of the two. Several embodiments are disclosed and include the use of a Livshits-Teichner generator to extract water and unburned hydrocarbons from exhaust of combustion engines, to collect potable water from exhaust of combustion engines, to use the vortex generation as an improved heat process mechanism, to mix gases and liquid fuel efficiently, and an improved Livshits-Teichner generator with baffles and external condensation.

### FIELD OF THE DISCLOSURE

The present disclosure generally relates to an apparatus and system for condensation and collection of a liquid suspended in a gas, and more specifically, to an apparatus for condensation of water from air with a geometry designed to emphasize adiabatic condensation of water using either the Joule-Thompson effect or the Ranque-Hilsch vortex tube effect or a combination of the two.

### BACKGROUND

Liquids may be in stable equilibrium within a gas. For example, water vapor, the gas phase of water under normal atmospheric conditions, is found in air in a relative humidity level ranging from a couple percentiles to saturation. This water vapor is generally evaporated from a liquid through the absorption of kinetic energy. When such water vapor leaves a volume of water, the rest of the water is cooled via a process called evaporative cooling. Humans sweat perspiration at the surface of their skin to cool the body.

As water vapor enters the air, relative humidity increases. Humidity is generally expressed in specific humidity or percentage of relative humidity. The temperatures of the atmosphere and the water surface determine the equilibrium vapor pressure. At 100% of relative humidity, the partial pressure of the water vapor is equal to the equilibrium vapor pressure. This effect is also called complete saturation. At a saturated atmospheric atmosphere at a temperature of 30° C., 30 grams of water can be stored in one cubic meter of air (0.03 ounce per cubic foot).

Since the molecular weight of water is 18.02 g/mol and the molecular weight of air is approximately 28.57 g/mol at standard temperature and pressure (STP), a mixture of water vapor and air has a molar volume of 22.414 liter/mol at STP. The saturation fraction of water in air at sea level increases from approximately 0.7% at 0° C., to 1.7% at 20° C., to 3% at 30° C. The maximum partial pressure (saturation pressure) of water vapor in air varies with temperature of the air and the water vapor mixture. For a given quantity of water vapor in air, as the air is cooled past the saturation pressure, water is extracted via condensation from the air. This condensation occurs in proximity of the gas on any surface capable of absorbing heat. A plurality of complex devices exist in the marketplace to extract liquids from gases, but these devices are bulky, require activation energy, and have moving parts. Devices and methods of extracting water vapor without activation energy or moving parts are needed. Water collected from condensation can also be blended into fuel in some types of combustion engines.

In thermodynamics, the Joule-Thomson effect, also known as the Joule-Kelvin effect or Kelvin-Joule effect, describes the temperature change of a gas or liquid when it is forced through a valve or a conduit while being insulated so that no heat is exchanged with its immediate environment. At room temperature, all gases except for hydrogen, helium, and neon cool upon expansion via the Joule-Thompson effect. An adiabatic (no heat exchanged) expansion of gas can be effected where a gas with a liquid phase at initial pressure P₁ flows into a region of lower pressure P₂ via a release mechanism under steady-state conditions and without a change in kinetic energy. During this process, enthalpy remains unchanged and causes cooling of the gas. This gas may in turn be warmed if placed in contact with a heat sink, which is also cooled in turn. As the gas cools and is placed in contact with a cold surface, condensation of the liquid fraction that reaches localized saturation occurs.

The Joule-Kelvin rate of change in temperature (T) with respect to a pressure P in a process at constant enthalpy H is the Joule-Thompson coefficient μ_{JT}. This coefficient is expressed in terms of a gas's volume (V), the heat capacity at constant pressure CP, and the coefficient of thermal expansion of a gas (α), which is expressed as the following equation:

$${μ}_{JT} = {( \frac{\partial T}{\partial P} )}_{H} = \frac{V}{{C}_{P}} ( α T - 1 ) )$$

As the gas cools, the coefficient μ_{JT} remains positive as long as the partial derivative of the temperature (∂T) is negative as the partial derivative of the pressure (∂P) also remains negative due to a loss of pressure from P₁ to P₂. In a gas with a fixed quantity of water vapor, as the pressure drops as the positive Joule-Thompson coefficient between two successive areas in the flow of a gas is calculated. The conditions may exceed the saturation point and force local condensation. What is known in the art is the use of the Joule-Thomson effect to cool down a gas.

Another effect known to cool a stream of gas is the Ranque-Hilsch vortex tube. In a mechanical device, compressed gas can be separated into a hot and a cold stream using no moving parts under the Ranque-Hilsch vortex tube effect. Pressurized gas is injected tangentially into swirl chamber and accelerates to a high rate of rotation. Due to the conical nozzle at an end of the tube, only the outer shell of the compressed gas is allowed to escape at that end. The remainder of the gas is forced to return in an inner vortex of reduced diameter within the outer vortex. There is no commonly accepted theory for this effect, and there is debate as to which explanation is best or correct. What is usually agreed upon is that the air in a tube experiences mostly “solid body rotation,” which simply means the rotation rate of angular velocity of the inner gas is the same as that of the outer gas. There are currently very few industrial applications of this effect. One of these rare applications includes using the vortex tube energy separation as a method to recover waste pressure energy from high and low pressure sources. See Sachim U. Nimbalkar, Dr. M. R. Mueller, “Utilizing waster Pressure in Industrial Systems.” Energy: Production, Distribution, and Conservation,” ASME-ATI 2006, Milan. What is known in the art is the use of the Ranque-Hilsch vortex tube effect to cool a gas.

What is needed is an apparatus and an associated method of use for the cooling of gas and an apparatus also adapted for the extraction and condensed liquid from the gas, along with a method of production of liquid such as water from a gas such as air where the Joule-Thompson effect and the Ranque-Hilsch vortex tube effect are used alternately or in combination.

### SUMMARY

The present disclosure generally relates to an apparatus for the condensation of a liquid suspended in a gas, and more specifically, to an apparatus for the condensation of water from air with a geometry designed to emphasize adiabatic condensation of water using either the Joule-Thompson effect or the Ranque-Hilsch vortex tube effect or a combination of the two. Several embodiments are disclosed and include the use of a Livshits-Teichner generator to extract water and unburned hydrocarbons from exhaust of combustion engines, to collect potable water from exhaust of combustion engines, to use the vortex generation as an improved heat process mechanism, to mix gases and liquid fuel efficiently, and an improved Livshits-Teichner generator with baffles and external condensation.

### BRIEF DESCRIPTION OF THE DRAWINGS

Certain embodiments are shown in the drawings. However, it is understood that the present disclosure is not limited to the arrangements and instrumentality shown in the attached drawings.

FIG. 1 is schematic plan of a thermodynamic process for the condensation of liquid from gas where water is extracted from a gas such as an hot exhaust gas from an internal combustion engine.

FIG. 2 is a cross-sectional view of a Livshits-Teichner generator as part of the thermodynamic process shown as FIG. 1 according to an embodiment of the present disclosure.

FIG. 3 is an isometric view of a Livshits vortex generator used for turbulent mixing and cooling of air as part of the Livshits-Teichner generator of FIG. 2 according to an embodiment of the present disclosure.

FIG. 4 is a half section of the Livshits vortex generator of FIG. 3.

FIG. 5 is a transparent model of the Livshits vortex generator of FIG. 3.

FIG. 6 is a end view of another Livshits vortex generator having a smaller internal cavity and a heat exchange structure according to another embodiment of the disclosure.

FIG. 7 is a half section of the Livshits vortex generator of FIG. 6.

FIG. 8 is a half section of another type of heat exchange structure for placement within an internal cavity of a Livshits vortex generator according to another embodiment of the present disclosure.

FIG. 9 is another type of heat exchange structure for placement within an internal cavity of a Livshits vortex generator according to another embodiment of the present disclosure.

FIG. 10 is an isometric view of another embodiment of Livshits vortex generator used for turbulent mixing and cooling of air as part of the Livshits-Teichner generator of FIG. 2 where the tangential channels are of variable width according to an embodiment of the present disclosure.

FIG. 11 is a transparent version of the half section illustration of the Livshits vortex generator of FIG. 10.

FIG. 12 is the cross-sectional view of the Livshits-Teichner generator of FIG. 2 where filtering material is located within the internal cavity.

FIG. 13 is the schematic plan of a thermodynamic process for the condensation of liquid from gas where water is extracted from a gas such as hot exhaust gas from an internal combustion engine of FIG. 1 where a device for the activation of a fuel mix is included as part of the process of the internal combustion engine.

FIG. 14 is another half isometric view of another Livshits-Teichner generator according to another embodiment of the present disclosure with kinetic energy brake disks used with several Livshits vortex generators and a water collection end.

FIG. 15 is another embodiment of the Livshits vortex generator according to FIG. 3 with partial internal channels and full external channels according to another embodiment of the present disclosure.

FIG. 16 is a plan view of the dynamic flow of gas in a Livshits vortex generator in a Livshits-Teichner generator and external pipe as shown in FIG. 14 according to another embodiment of the present disclosure.

FIG. 17 is the Livshits vortex generator of FIG. 14 with a diaphragm and a biasing element within the internal cavity of the Livshits vortex generator according to another embodiment of the present disclosure.

FIG. 18 is the Livshits vortex generator of FIG. 14 where the dynamic flow is indicated and the biasing element is shown in an open configuration.

FIG. 19 is the Livshits vortex generator of FIG. 14 where a turbine generator is placed within the internal cavity according to another embodiment of the present disclosure.

### DETAILED DESCRIPTION OF THE INVENTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

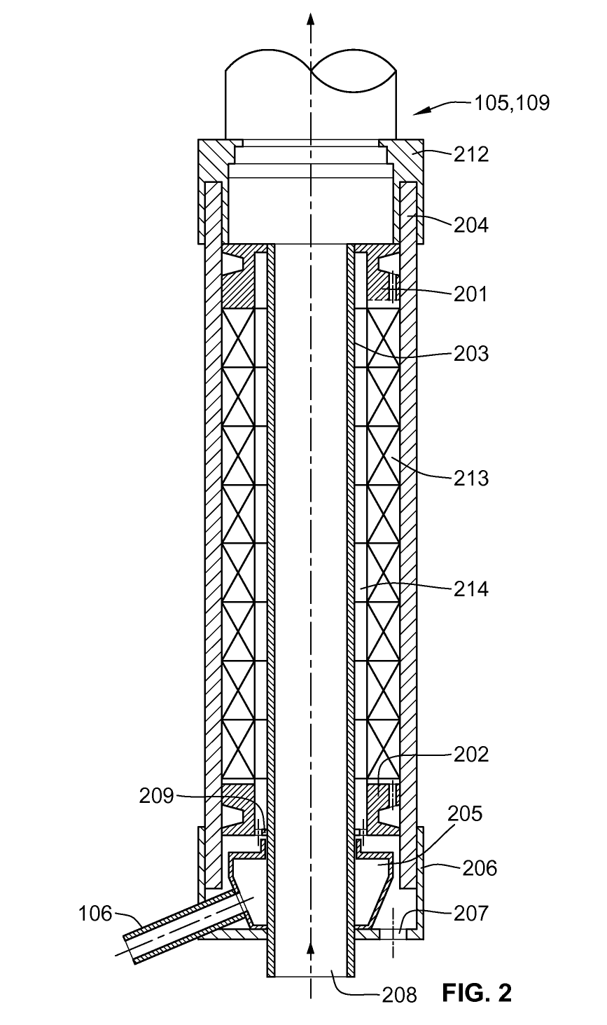

Obtaining liquid from gas, such as water from air or water from exhaust gases of vehicles, can be very desirable when water is not readily available. Water vapor is normally present in air even in extremely dry climates, such as deserts, or in heated exhaust gases of vehicles. Gases can be naturally pressurized or can be pressurized using a pump before they enter a process. In one embodiment, water is collected using a Livshits-Teichner generator 105, 109 as seen in FIG. 2 made of a plurality of Livshits rings 213 to extract water from exhaust gas to blend back into fuel for specific combustion engines where a fraction of water is useful to the fuel mix. In another embodiment, water is collected using the Livshits-Teichner generator to extract potable water from a gas.

Because of the compact size of the Livshits ring 213, and thus the compact size of the Livshits-Teichner generator 105, 109, the generators may be added to existing systems and processes to increase overall efficiency. Further, because no moving parts or external energy is needed aside from the pressure of input gas within the Livshits-Teichner generator 105, 109, no additional energy source is needed and the generators can be used in conjunction with existing engines, fuel pressure pumps, compressors, exhaust gas flow, or any device where liquid separation from a gas is contemplated. In yet another embodiment, condensation may also be used to capture small particles such as soot particles from an exhaust gas to return unburned oxides to the combustion chamber for improved efficiency of devices.

While no particular application for the Livshits-Teichner generator 105, 109 is given, what is contemplated is the use of the generator in any stationary or nonstationary equipment, such as but not limited to a residential, commercial, industrial, or defensive application.

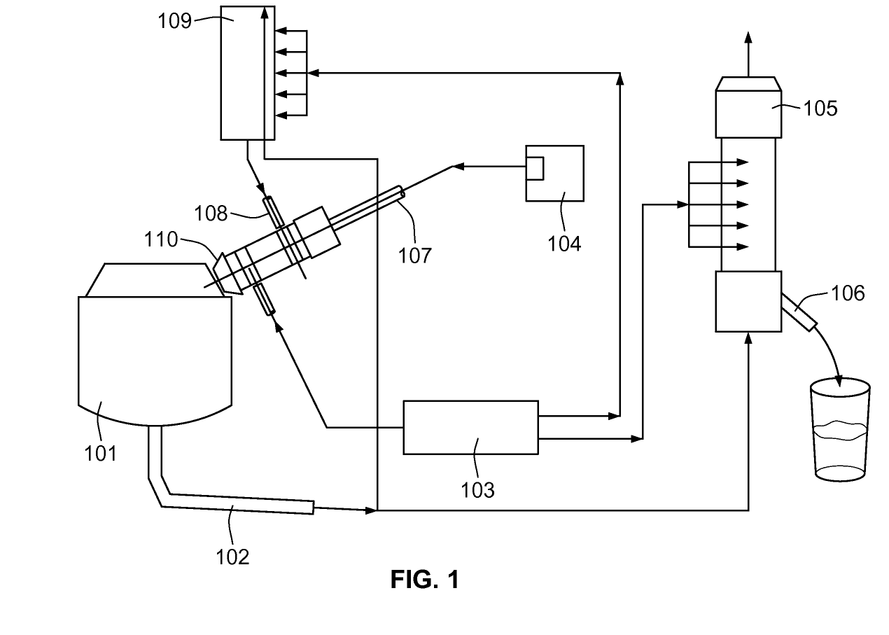

FIG. 1 shows a combustion cycle such as a diesel engine cycle where a tank 104 containing fuel such as diesel fuel is connected with a pump via a fuel pipeline 107 to a device for mixing and activations of a fuel mix 110. The fuel mix device 110 is described with greater specificity in International Patent Application No. PCT/US2008/075366 filed on Sep. 5, 2008, and International Patent Application No. PCT/2008/075374 also filed on Sep. 5, 2008, where both applications are hereby fully incorporated herein by reference. The device 110 allows for the production of a mixture at an entry of a diesel engine 101 of an incompressible fluid, such as the diesel fuel from the tank 104 mixed with air from a compressor 103 and/or one or several auxiliary liquids such as water introduced at a connector 108 into the mixture.

As shown in the diagram of FIG. 1, water is introduced at the connector 108 from a first Livshits-Teichner generator 109 for producing water from exhaust gases of the diesel engine 101. The engine 101 produces exhaust gases with water at a gas pipe 102 as byproduct of the burning reaction in the engine. In the diesel cycle, water vapor is often produced as a byproduct along with unburned hydrocarbons. As shown, part of the exhaust is diverted to the Livshits-Teichner generator 109 for extraction of water as explained hereafter and regeneration of the unburned fuel.

FIG. 1 shows that the first Livshits-Teichner generator 109 produces water and also traps small sooty particles of carbon that may be transported back into the fuel mixture to improve the efficiency of the overall cycle. FIG. 1 also shows a second Livshits-Teichner generator 105 for extracting water from the exhaust fumes at gas pipe 102. According to another embodiment described hereinafter, the second Livshits-Teichner generator 105 is used only for capturing water without soot particles to extract potable water at the output 106 of the device. In FIG. 1, the compressor 103 produces compressed air for operating the first Livshits-Teichner generator 109, the second Livshits-Teichner generator 105, and the device for mixing and activations of a fuel mix 110. One of ordinary skill in the art will recognize that while a compressor 103 is shown as a source for pressurized gas for these devices 109, 105, and 110, what is contemplated is the use of any source of pressurized gas, either from an external source or an internal source, such as the outlet of the Livshits-Teichner generators 105, 109.

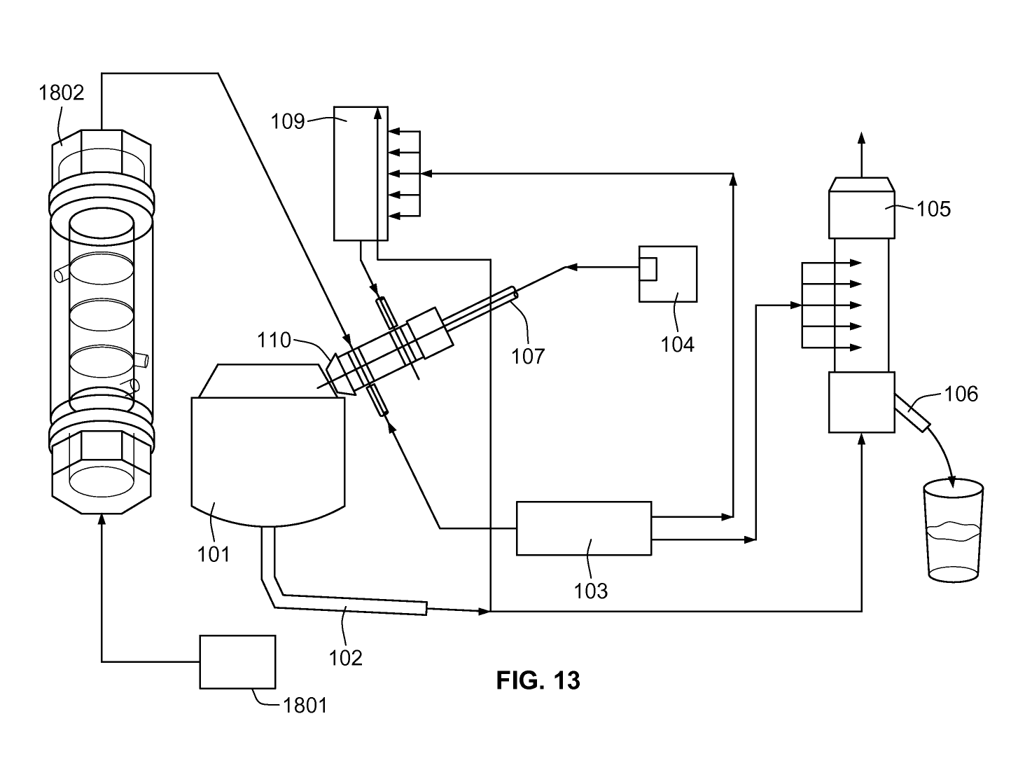

FIG. 13 shows the same diagram as found in FIG. 1 but where a second external source of fuel in a tank 1801 is connected to another inlet of the device for mixing and activations of a fuel mix 110. The source of fuel is a liquefied natural gas or other gaseous fuel released in a third Livshits-Teichner generator 1802 also connected to the compressor 103 for the purpose of vortex mixing, temperature control, or extraction of a fraction of partial pressure of a liquid in suspension in the gas fuel. FIGS. 1 and 13 show generally the versatility of the Livshits-Teichner generator generally as part of any thermodynamic system for the control of the characteristics of a gas, such as the extraction of a liquid from a gas, drying a gas, heating or cooling a gas, or even the possibility of mixing gases.

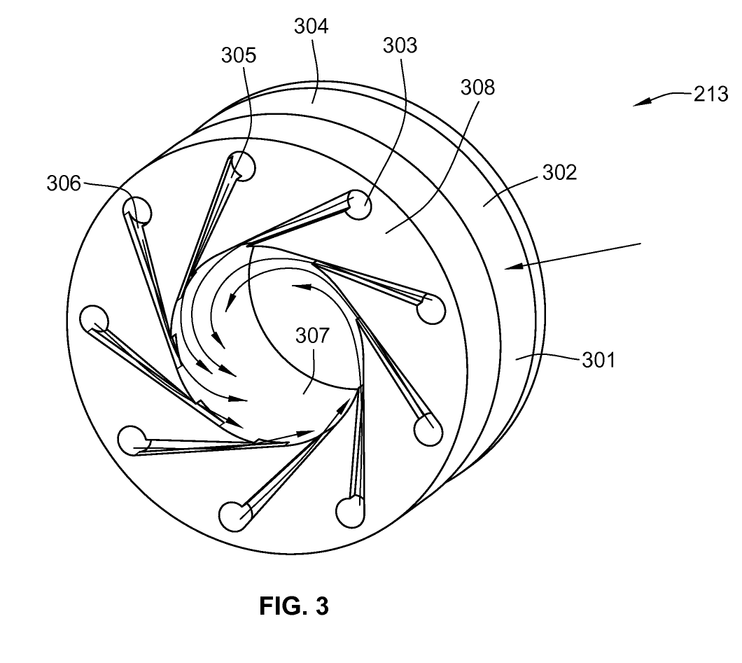

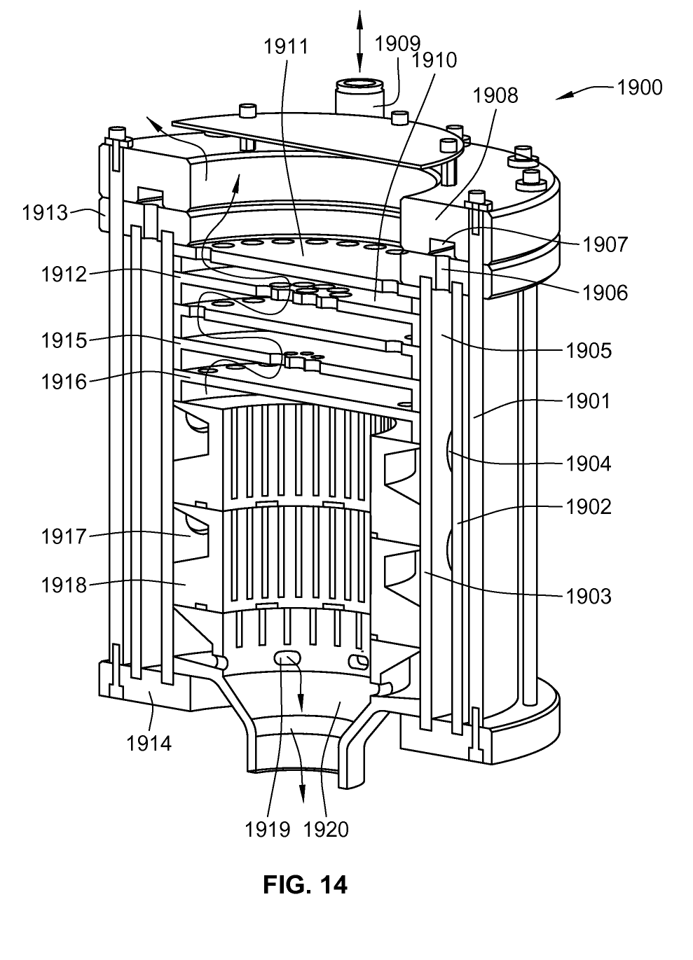

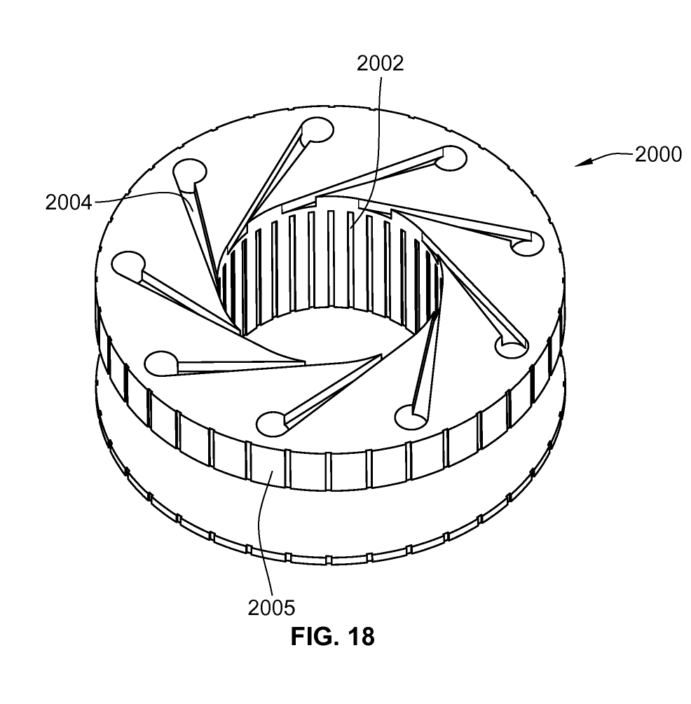

Turning now to the Livshits-Teichner generator 105 or 109 itself, which is shown in greater detail in FIG. 2, the device includes the output of a fluid such as portable water 106 or hydrocarbon-filled condensed water 108 as shown in FIG. 1. The device has an outer shell made of an external cylindrical housing 204 connected to two end flanges 212, 206. Within the main portion of the generator 105, 109, a series of Livshits rings 213 are stacked vertically on top of each other. Several embodiments of these rings 213 are shown at FIGS. 3-5, 10-11, and 15. In FIG. 2, only the top ring 201 and the bottom ring 202 are shown in detail. The other rings are shown figuratively as being stacked between rings 201, 202. For example, the Livshits-Teichner generator shown in FIG. 14 shows only two stacked rings 1918. FIG. 2 illustrates a generator 105 having 10 stacked rings 213. The use of any number of ring to create a generator of a desired size and configuration is contemplated. The size of the Livshits rings 213 are also calibrated to optimize the flow and create the needed pressure decrease to obtain the proper level of condensation resulting from localized saturation.

In one embodiment, the Livshits rings 213 are carved out from a single block of metal having high thermal storage capacity. The rings 213 may be made of stainless steel, but other metals, such as, for example, titanium, iron, aluminum, and copper, are contemplated. FIG. 2 shows the Livshits-Teichner generator 105 in a vertical configuration. In this configuration, liquid condensate drops under gravity to the bottom receptacle 205 where it can be collected before exiting the generator 105 via the outlet 106. While the generator 105 is shown in a vertical orientation, one of ordinary skill in the art of heat exchangers will understand that the orientation of the generator 105 can be changed with adequate design modifications to produce a collection vessel at the bottom of the housing made of a top flange 212, a bottom flange 206, and a housing wall 204 fixed using a fixation means to the top and bottom flanges 212, 206, respectively.

In FIG. 2, the stacked rings 213 are oriented so the largest thickness of metal on the outer edge of the ring is located closest to the middle portion of the generator 105. While this configuration is optimized to increase thermal inertial and condensation capacity, the rings 213 can be stacked in any configuration within the generator 105. A heat exchange pipe 203 can be slid into the inner opening of the rings 213 to insulate the incoming gas within the exchanger device for cooling to a release exit gas as shown by the arrow or when insulated and the gas do not mix via the flange opening 207. As shown by large arrows on the upper and lower ends of the generator 105 in this embodiment, the pipe 203 isolates the structure and allows it to operate as a heat exchange to remove heat from the pipe 203 and ultimately from the exhaust gas. If instead of a pipe 203 capable of insulating the flows, a heat exchanger as shown in FIG. 7 is used, the incoming compressed air shown by the arrows can be merged and mixed into the upcoming stream of gas to be dried. Returning to FIG. 2, small openings 209 can be made for the compressed and cooled air to reach the flange opening 207 on one side and for the dripping water droplets to enter the receptacle 205 on the other side.

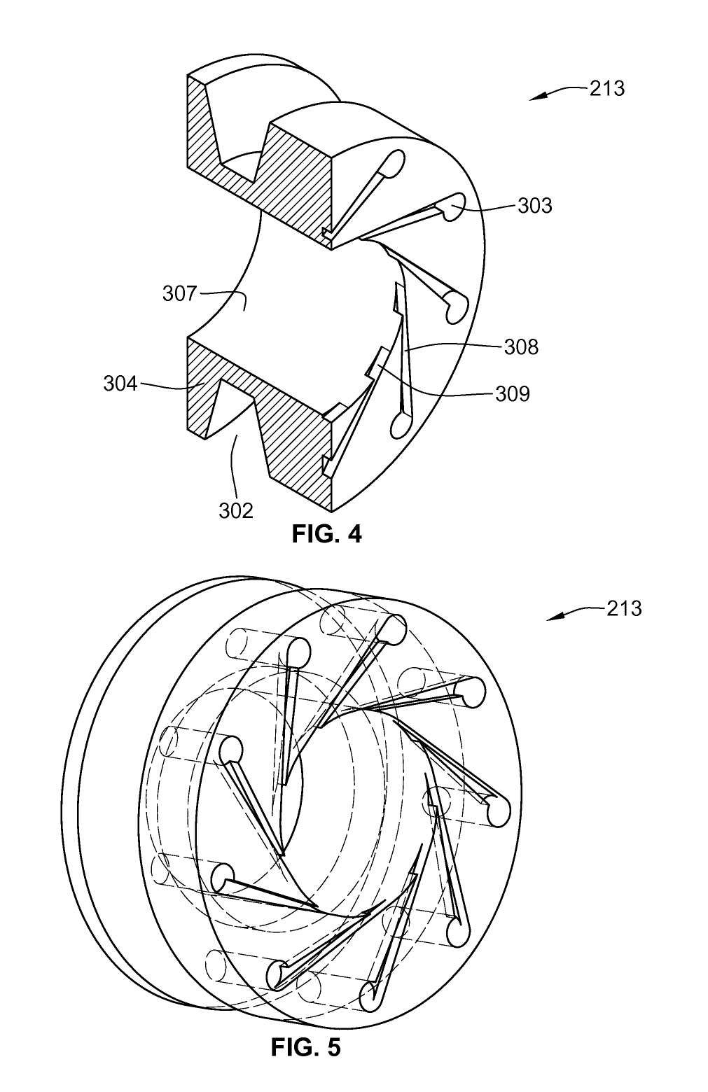

An opened area 214, such as a cylindrical internal cavity, can be made between the rings 213 and the pipe 203 to allow for the vortex be created. FIG. 3 is an isometric view of a Livshits ring 213 in a Livshits vortex generator 105, 109 according to an embodiment of the present disclosure. FIGS. 4-5 are a half- and a semitransparent views of the ring 213 to illustrate the geometry and flow of the compressed air within the ring 213. Compressed air is placed in contact with the external surface of the ring 213 as shown by the arrow, and more specifically, is in contact with a ring channel 302. Pressurized gas then flows in openings 303 down into grooves 306 that open into an internal cavity 307 shown here as a cylindrical cavity with a cylindrical surface.

In one embodiment, to simplify the manufacture of the Livshits ring 213, the openings 303 are performed in a top surface 308 to the ring channel 302, and the grooves 306 are carved in the top surface 308. In a preferred embodiment, the openings 303 are parallel to the principal axis of the Livshits-Teichner generator 105 and tangential to the ring channel 302, and the grooves 306 are tangential to the openings 303 and are oriented inwardly from the openings 303 to the internal cavity 307 to create a directional flow of the gas traveling along from the ring channel 302 then up and through an opening 303 and through the groove 306 to finally arrive in the internal cavity 307. Arrows illustrate the directional flow created in the internal cavity 307.

Once the gas has traveled along the ring channel 302, up the opening 303, and along the groove 306, it is then released into the internal cavity 307 using the Bernoulli principle but at a different pressure, thus creating a Joule-Thompson cooling effect. The same gas, is then pushed in a vortex configuration in the internal cavity 307 creating a Ranque-Hilsch vortex tube cooling effect. The grooves 306 as shown have a variable section and a rounded lower surface 305 but can also have a flat section. These grooves 306 are once again designed for simplicity in manufacturing (e.g., the need to carve out a groove instead of drilling a full hole) by having the grooves 306 closed by placing the top surface 308 against an adjacent flat surface such as an adjacent Livshits ring 213. Boring holes to form the passageway for gas from the internal cavity 307 to the openings 303 or even boring a passageway directly from the internal cavity 307 to the ring channel 302 is also contemplated.

In the above embodiment, the grooves 308 are shown with a variable section that decreases as the groove 308 gets closer to the internal cavity 307. This configuration allows the limitation and control of the pressure loss along the groove portion and thus create the greatest pressure drop (P₁−P₂) localized at the opening between the groove 308 and the internal cavity 307. As a consequence, the temperature loss under the Joule-Thompson cooling effect is greatest at the surface of the internal cavity 307. Also, because of the creation of a vortex in the internal cavity 307 based on the orientation of the grooves 308, the Ranque-Hilsch vortex tube cooling effect is also greatest at the surface of the internal cavity 307.

FIG. 4 shows a particular geometry of the groove openings 309 in the internal cavity 307 and shows how the walls 304 are inclined as part of the ring channel 302 to help with the flow of gas and the transportation of excess condensation. In a preferred embodiment as shown in FIG. 4, the Livshits ring 213 is made of a single block of metal. The thickest portion of metal between the grooves 308 and the ring channel 302 serves as a heat sink for the accumulation of a greater portion of the heat from the cooling effect at the groove opening 309. While one configuration of groove is shown, operating in tandem with the openings 303, resulting in the creation at of two concurring cooling effect on the internal cavity 307, the creation of any structure capable of recreating these conditions via a series of directional flow channels in structures is contemplated.

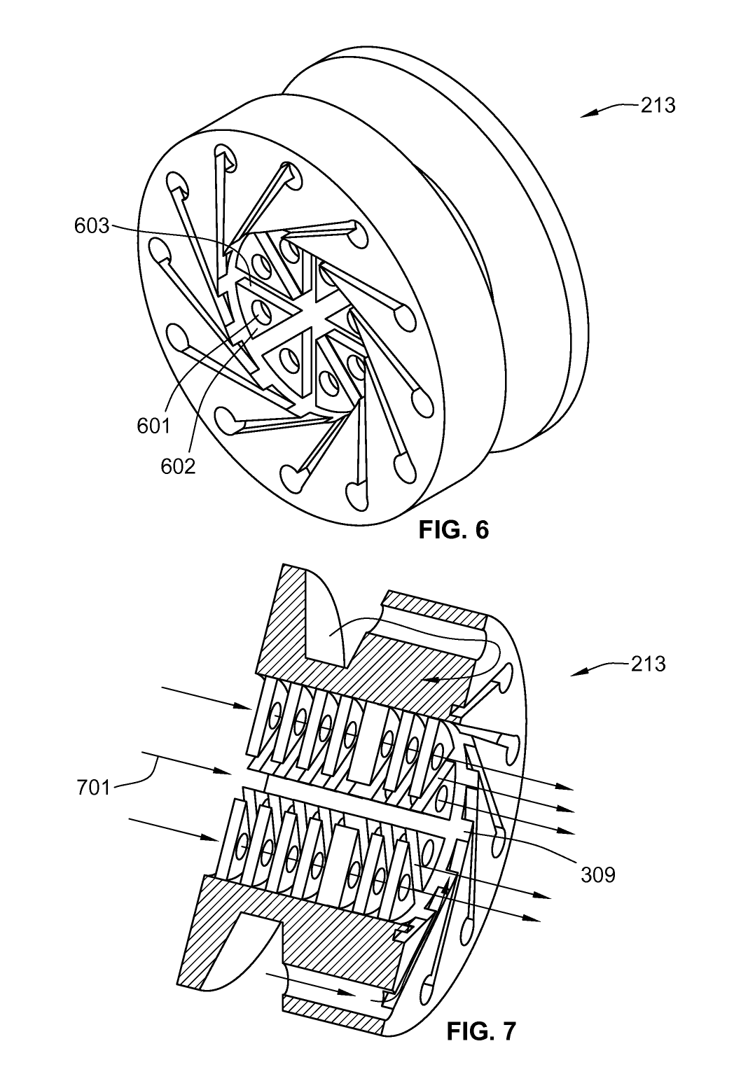

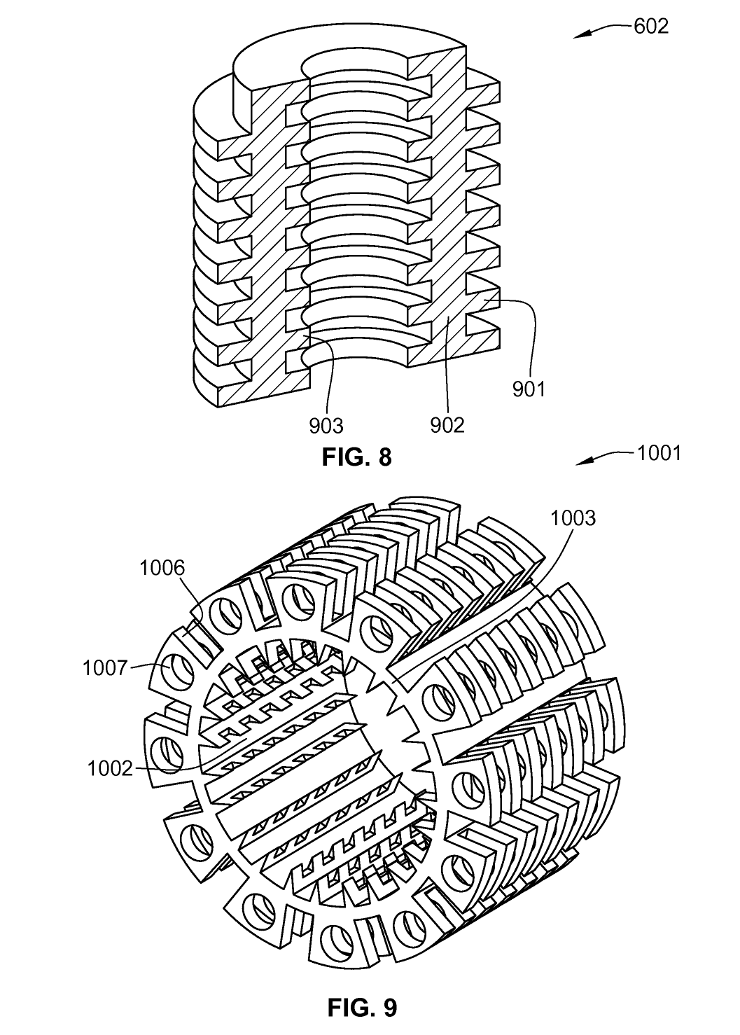

FIG. 6 and associated FIG. 7 illustrate a Livshits ring 213 where an internal heat exchange structure 602 is equipped with different openings 601, 603 and radial fins for allowing greater surface area connection between an internal gas from an external source 701 and the compressed gas. In one embodiment, the internal heat exchange structure 602 does not cover the area where openings release gas past the groove openings 309 to preserve the Ranque-Hilsch vortex tube cooling effect. While small segments are shown FIGS. 6-7 in the shape of pie slices, FIG. 8 shows a different configuration of heat exchange structure 902 that may be used instead of the internal heat exchange structure 602 where fins are located both on the external 901 and the internal 903 portion of the heat exchange. One obvious advantage is to preserve in the central part of the internal cavity 307 even when equipped with the structure 902 a strong central flow of gas and a capacity to produce a strong vortex.

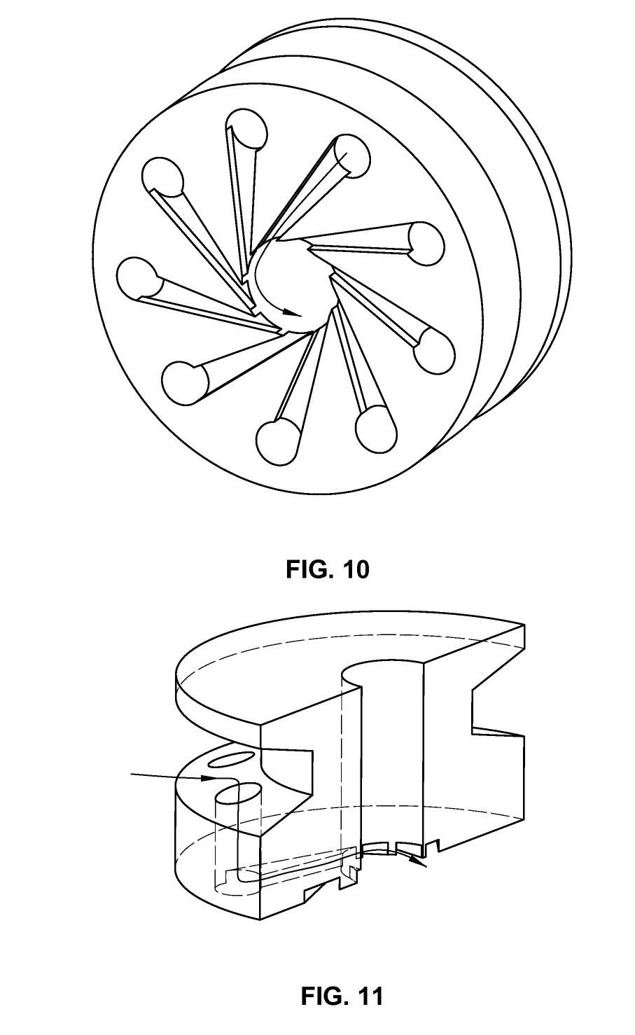

FIG. 9 shows yet another type of internal heat exchange structure 1001 made with square external radial fins 1006 with circular openings 1007 and small longitudinal fins 1002, also with longitudinal square openings. While three different types of internal heat exchange structure 602, 902, and 1001 are shown in FIGS. 6-9, respectively, the use of any type of heat exchange technology, either fixed to the internal cavity 307 of the Livshits ring 213 or a longer structure that can be slid into the internal cavity 307 formed by a plurality of stacked Livshits rings 213 as part of a Livshits-Teichner generator 105, is contemplated.

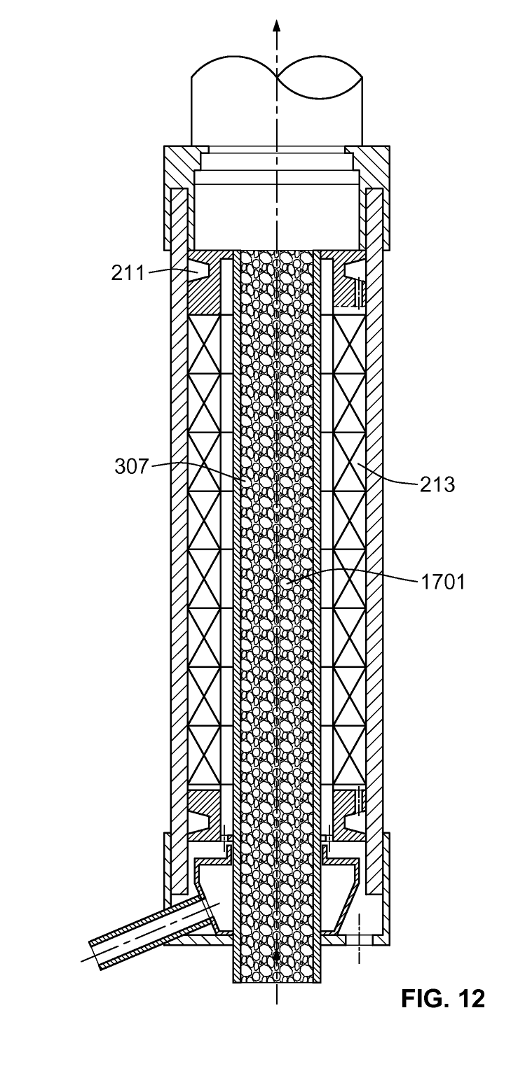

FIG. 12 shows a Livshits-Teichner generator 105 where, in lieu of a rigid heat exchange, a wire mesh 1701 made of a deformed wire is inserted into the internal cavity 307. In another embodiment of the Livshits ring 213 as shown on FIGS. 10-11, the internal cavity 307 is smaller in order to maintain a high velocity of air to compensate for the pressure reduction associated with the wire mesh 1701 slid into the internal cavity 307. By using an internal cavity 307 having a small radius, the Ranque-Hilsch vortex tube cooling effect is increased and the Joule-Thompson cooling effect is proportionally decreased.

The Livshits-Teichner generator 105 offers many commercial advantages including its compactness, its operation without moving parts, the lack of need for an external energy source aside from a source of pressurized gas, the ability to install this technology on existing systems, and the modular capacity of the system that allows for the change to different configurations by simply changing a portion of the generator. In the case of efficient removal of water and unburned hydrocarbons from exhaust gases, the gases are filtered and reused as part of the cycle for an ultimate reduction in harmful gas emission. While a handful of uses are described, the implementation of this technology to any field where gases or liquids must be mixed, separated, and/or cooled is contemplated.

FIG. 14 shows another embodiment of the Livshits-Teichner generator 1900 with other flow changes. The generator 1900 still includes an inlet 1909 for the entry of compressed air that ultimately travels along a channel 1907 down a flange opening 1906 to an intermediate flange 1913 and into an internal chamber 1905, also known as the high-pressure chamber, located between an external housing 1902 and an internal support membrane 1903. The air then flows into the heart of the generator 1900 from the internal chamber 1905 via a series of windows 1904 made in the internal support membrane 1903. In one embodiment, these windows 1904 are semi-elliptical in shape, but any geometry of window is contemplated as long as its opening aligns with the ring channels 1917 in each of the Livshits rings 1918.

A series of baffles 1912, 1915, 1911, and 1916, each with different size holes located at different radii from the center, creates a baffle area where the air must travel as shown by the arrow before it leaves the generator 1900. Bolts are used to connect the top flange 1908 with the bottom flange 1914, closing the intermediate flange 1913 over both the internal support membrane 1903 and the external housing 1902. Screws are used along with connection rods 1901 to fasten the device in place. While one industrial method of closure is illustrated, all other commonly known methods are contemplated, such as but not limited to external clips, the use of an external casing, magnetic elements, seal-locked flanges, clipped-in flanges, and the like.

In the Livshits-Teichner generator 1900, the bottom Livshits ring as shown is modified to include holes 1919 for draining excess water 1920 that may condense on the external surface of the rings 1918. FIG. 15 shows another embodiment of a Livshits ring 2000 where drain grooves 2002 and 2005 are made on both the internal 2002 and the external surface 2005 of the ring 2000. These drain grooves 2002, 2005 allow for easy transfer of liquid along these surfaces and increase the effective contact area of these surfaces. As shown, the absence of a groove is found in the area where gas is released from the grooves 2004. While regularly spaced grooves 2002, 2005 are shown around the periphery of the ring 2000, the use of any type of passageway capable of transporting fluid or gas effectively from one location to another is contemplated. For example, these grooves 2002, 2005 may be calibrated in size and shape based on the pressure in the internal chamber 1905 and the surface tension of the liquid to be transported. For example, if water droplets must be able to slide down the grooves, the grooves 2002, 2005 must be of sufficient size and geometry to allow for droplets to fall down and be transported under their own weight.

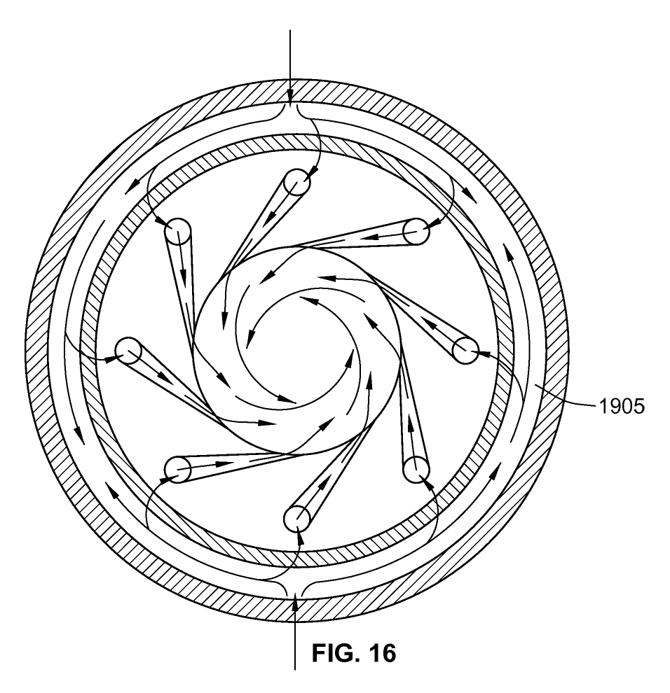

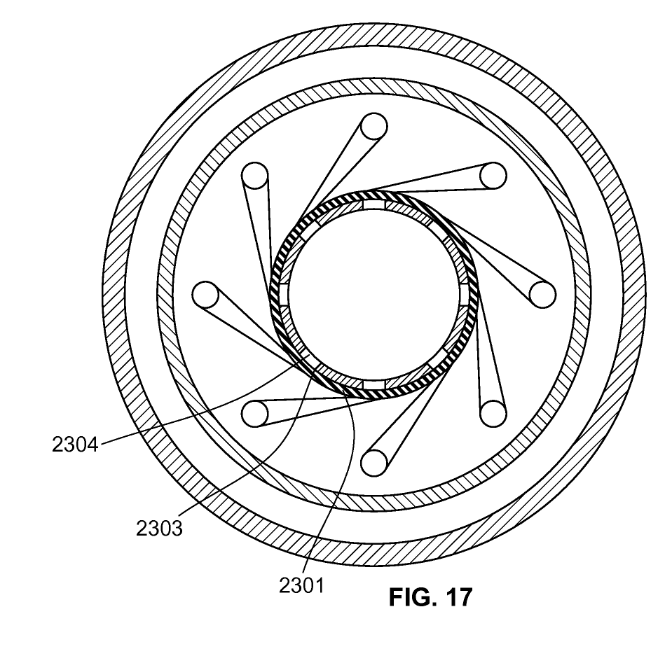

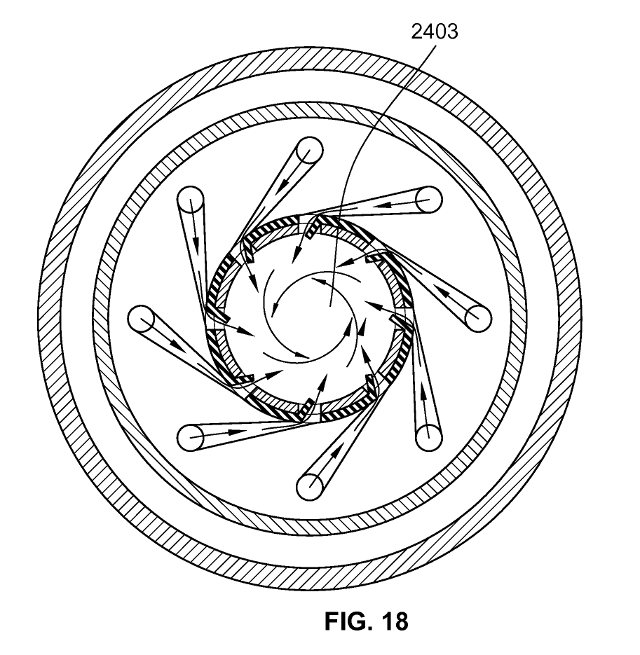

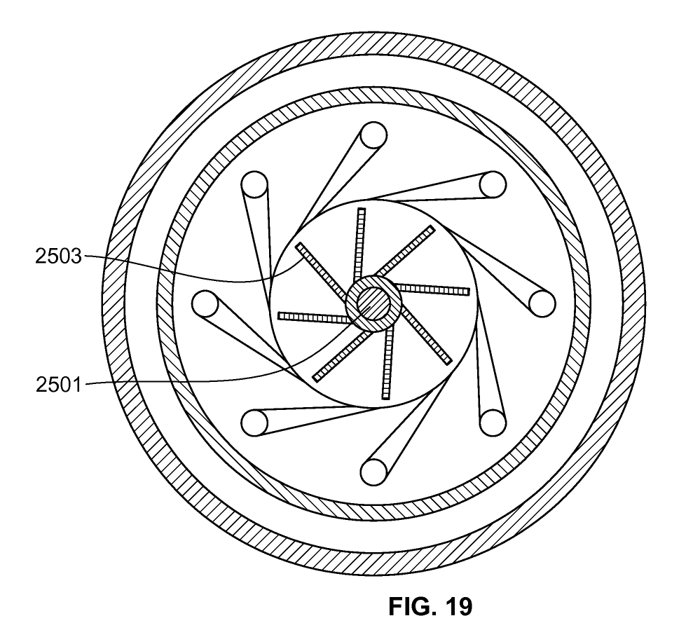

FIG. 16 shows how air can flow in the generator 1900 in the internal chamber 1905 through the different windows (shown by the arrows). FIG. 17 shows the use of a diaphragm 2301 on the internal surface 2303 of the internal cavity. Small holes can be made to offer further reduction in area and create a wider area where the Joule-Thompson cooling effect can take place. An internal biasing element 2304 with small, window-sized areas are aligned with any puncture holes made in the diaphragm 2301 can be used to control the opening of the diaphragm 2301. The membranes located in the internal surface 2303 area allow for the protection and insulation of the Livshits ring 2000 to prevent heat transfer into the ring 2000. For example, in a case where primarily the gas must be cooled, such a system may be useful. Finally, FIG. 18 shows a turbine 2501 with pales 2503 that can be inserted into the cavity to recycle a portion of the vortex momentum into electricity.

In one embodiment, the Livshits-Teichner generator has a cylindrical surface of 245 mm and a height of 800 mm where 15 Livshits rings are stacked in the generator. The use of the Livshits-Teichner generator in conjunction with entry filters to purify the resulting condensate is also contemplated. In yet another embodiment, oil vapor can be removed from compressed air, including, for example, cryogenic devices where pump defects result in evaporation of oil into a very low-pressure stream. Pre- or post-water treatment is also contemplated, such as the inclusion of calcium or other minerals to stabilize demineralized water products. Zeolites can also be used as an alternative to filtration.

In one embodiment, the apparatus for the condensation of a liquid in suspension in a gas includes a high pressure gas chamber 214 with a pressurized input gas released therein as shown by the arrow in FIG. 16 and where the apparatus includes an opening 303 as shown on FIG. 3 for an expansive release of the pressurized input gas from the high-pressure gas chamber 304 to a low-pressure gas chamber 307 in the embodiment shown in FIG. 3. The low-pressure gas chamber 307 may include a condensation surface for collecting a portion of the liquid suspended in the gas as the expansive release cools the gas during the passage from a high-pressure state to a low-pressure state and saturates a portion of the liquid suspended in the cooled gas on the condensation surface and the cooling results from a Joule-Thompson expansive cooling of the gas and a Ranque-Hilsch vortex tube cooling of the gas as described above.

In the apparatus shown in FIG. 3, the high-pressure gas chamber 304 includes a circumferential cavity on the external portion of a ring 213 and the low-pressure gas chamber 307 is made of a cylindrical internal cavity in the center portion of the ring 213. The opening 303 may also include a vertical opening shown in dashed lines in FIG. 5 tangential to the circumferential cavity 304 and an angled groove 306 and where the gas is released from the circumferential cavity 304 to the cylindrical internal cavity 307 via the vertical opening 303 and the angled groove 306 and is subsequently released at an angle in the cylindrical internal cavity. The groove 306 may be angled 305 to decrease linearly the section of the groove 306 to increase the speed of the flow.

FIG. 14 shows a generator 1900 with a baffle area as shown on top 1911, 1912, 1915, and 1916 for the condensation of condensate in the gas moving back up the structure as shown by the arrow. The baffle area may includes a series of adjacent plates 1911, 1912, 1915, and 1916 with a plurality of venting holes 1910 wherein the location of the venting holes on each adjacent place is sufficient to create a serpentine circulation of the gas between adjacent plates. The baffle area may also include a series of adjacent plates with each front and back in opposition, where each plate is in perpendicular alignment with the cylindrical cavity where cooling occurs.

The rings 213 may include an external surface continuous with the circumferential cavity 304 and an internal surface continuous with the cylindrical internal cavity 307 where both the external surface and the internal surface includes drain grooves a shown in FIG. 18.

In another embodiment, the condensation cavity for the condensation of a liquid suspended in a gas includes a low-pressure cylindrical cavity wall shown as the wall of cavity 307 having a length along its axis including a plurality of angled openings created by the grooves 306 shown in FIG. 18 along the length of the cavity for releasing circumferentially within the cylindrical cavity 307 a pressurized gas where the pressurized gas expands at the angled openings into the low-pressure cylindrical cavity 307, the pressurized gas also enables creation of a vortex of the gas at low pressure into the low-pressure cylindrical cavity 307 for cooling, and the vortex and the expansion cools the high-pressure gas wherein a liquid suspended in the gas condenses on the low-pressure cylindrical cavity wall.

As shown in FIGS. 2 and 14, for example, the low-pressure cylindrical cavity wall is formed by stacking at least two rings 213, each with a cylindrical internal cavity 307 in the center of each ring 213 where the angled openings are a series of grooves 306 made at regular angular intervals shown as 8 grooves along a 360° circle on the radius of each of the at least two rings 213.

FIGS. 1 and 13 show a water extraction system for the condensation of a liquid suspended in a gas, the system including a compressor 103 having a pressurized gas outlet for exiting high-pressure gas, a Livshits-Teichner generator 105, 109, or 1802, respectively, with a high-pressure gas chamber 1905 connected to the pressurized gas outlet of the compressor 103 where the high-pressure gas includes a liquid such as water in suspension, and an opening for an expansive release of the pressurized input gas from the high-pressure gas chamber 1905 to a low-pressure gas chamber 307, wherein the low-pressure gas chamber includes a condensation surface such as the walls of low-pressure gas chamber 307 or the inner grooved surface 3 for collecting a portion of the liquid suspended in the gas.

The expansive release cools the gas during the passage from a high-pressure state to a low-pressure state and saturates a portion of the liquid suspended in the cooled gas onto the condensation surface, the cooling resulting from a Joule-Thompson expansive cooling of the gas and a Ranque-Hilsch vortex tube cooling of the gas. Water as condensate is then collected in the collector. As shown in FIG. 1, the high-pressure gas at generator 109 may include exhaust gas 102 from an internal combustion engine 101.

Finally, what is described is a method for the collection of a liquid suspended in a gas, comprising the steps of cooling a gas having a liquid in suspension below a saturation temperature of the liquid, wherein the cooling results from a Joule-Thompson expansive release of the gas at an opening and the creation of a Ranque-Hilsch vortex tube cooling within a cavity with the opening, allowing for the cooled gas in the cavity to contact a surface to allow the condensation of a saturated liquid portion at the surface and the collection of the saturated fluid.

The step of collecting the saturated water with unburned hydrocarbon particles is introduced into an engine producing exhaust gas to improve overall fuel efficiency of the engine, and the water with unburned hydrocarbon particles may be introduced back into the engine using a device for mixing and activation of fuel mix as shown in FIGS. 1 and 13.

It is understood that the preceding detailed description of some examples and embodiments of the present invention may allow numerous changes to the disclosed embodiments in accordance with the disclosure made herein without departing from the spirit or scope of the invention. The preceding description, therefore, is not meant to limit the scope of the invention but to provide sufficient disclosure to one of ordinary skill in the art to practice the invention without undue burden.

What is claimed is:

1. An apparatus for the condensation of a liquid suspended in a gas, the apparatus comprising:
a high-pressure gas chamber with a pressurized input gas released therein with a liquid suspended in the input gas; and
an opening for an expansive release of the pressurized input gas from the high-pressure gas chamber to a low-pressure gas chamber, wherein the low-pressure gas chamber includes a condensation surface for collecting a portion of the liquid suspended in the gas,
wherein the expansive release cools the gas during the passage from a high-pressure state to a low-pressure state and saturates a portion of the liquid suspended in the cooled gas onto the condensation surface, and wherein the cooling results from a Joule-Thompson expansive cooling of the gas and a Ranque-Hilsch vortex tube cooling of the gas.

2. The apparatus of claim 1, wherein the liquid is water and the gas is compressed air.

3. The apparatus of claim 1, wherein the liquid is water and the gas is a mixture of an engine exhaust gas and compressed air.

4. The apparatus of claim 1, wherein the high-pressure gas chamber includes a circumferential cavity on the external portion of a ring and the low-pressure gas chamber is a cylindrical internal cavity in the center portion of the ring.

5. The apparatus of claim 4, wherein the opening comprises a vertical opening tangential to the circumferential cavity and an angled groove, and wherein the gas is released from the circumferential cavity to the cylindrical internal cavity via the vertical opening and the angled groove and is released at an angle in the cylindrical internal cavity.

6. The apparatus of claim 4, wherein the cylindrical internal cavity includes a tube for the passage of an external gas.

7. The apparatus of claim 4, wherein the cylindrical internal cavity includes an internal heat exchange structure.

8. The apparatus of claim 7, wherein the heat exchange structure includes a plurality of radial fins.

9. The apparatus of claim 7, wherein the heat exchange structure includes internal longitudinal fins and external radial fins.

10. The apparatus of claim 8, wherein the heat exchange further includes internal and external fins.

11. The apparatus of claim 6, wherein the tube further includes a filtration element.

12. The apparatus of claim 11, wherein the filtration element is a wire mesh.

13. The apparatus of claim 1, further comprising a baffle area for the condensation of condensate.

14. The apparatus of claim 13, wherein the baffle area includes a series of adjacent plates with a plurality of venting holes, and wherein the location of the venting holes on each adjacent plate is different to create a serpentine circulation of the gas between adjacent plates.

15. The apparatus of claim 4, further comprising a baffle area with a series of adjacent plates with each front and back in opposition, and wherein each plate is in perpendicular alignment with the cylindrical cavity.

16. The apparatus of claim 4, wherein the ring includes an external surface continuous with the circumferential cavity and an internal surface continuous with the cylindrical internal cavity, and wherein the external surface includes drain grooves.

17. The apparatus of claim 16, wherein the internal surface includes drain grooves.

18. The apparatus of claim 4, wherein the high-pressure gas chamber includes an external housing and an internal support membrane with windows for the passage of the pressurized input gas to the circumferential cavity of the ring.

19. The apparatus of claim 4, wherein the ring further includes holes between the circumferential cavity and the cylindrical internal cavity for the passage of condensate.

20. The apparatus of claim 4, further comprising a turbine in the cylindrical internal cavity.

21. The apparatus of claim 4, further comprising a diaphragm with puncture holes in the cylindrical internal cavity.

22. The apparatus of claim 21, wherein the diaphragm further includes a biasing element to control the opening of the puncture holes.

23. A condensation cavity for the condensation of a liquid suspended in a gas, the cavity comprising a low-pressure cylindrical cavity wall having a length including a plurality of an angled openings along the length for releasing a pressurized gas circumferentially within the cylindrical cavity, wherein the pressurized gas expands at the angled openings into the low-pressure cylindrical cavity and the pressurized gas also enables for creation of a vortex of the gas at a low pressure into the low-pressure cylindrical cavity for cooling, and wherein the vortex and the expansion cools the high-pressure gas and wherein a liquid suspended in the gas condenses on the low-pressure cylindrical cavity wall.

24. The condensation cavity of claim 23, wherein the low-pressure cylindrical cavity wall is formed by stacking at least two rings, each with a cylindrical internal cavity in the center of each ring, and wherein the angled openings are a series of grooves made at regular angular intervals on the radius of each of the at least two rings.

25. The apparatus of claim 23, wherein the liquid is water and the gas is compressed air.

26. The apparatus of claim 23, wherein the liquid is water and the gas is a mixture of an engine exhaust gas and compressed air.

27. The apparatus of claim 23, wherein the cylindrical internal cavity includes a tube for the passage of an external gas.

28. The apparatus of claim 23, wherein the cylindrical internal cavity includes an internal heat exchange structure.

29. The apparatus of claim 27, wherein the tube further includes a filtration element.

30. The apparatus of claim 24, wherein at least one ring of the at least two rings includes a cylindrical internal cavity having longitudinal drain grooves.

31. A water-extraction system for the condensation of a liquid suspended in a gas, the system comprising:
a compressor having a pressurized gas outlet for producing high-pressure gas;
a Livshits-Teichner generator with a high-pressure gas chamber connected to the pressurized gas outlet where the high-pressure gas includes a liquid in suspension, and an opening for an expansive release of the pressurized input gas from the high-pressure gas chamber to a low-pressure gas chamber, wherein the low-pressure gas chamber includes a condensation surface for collecting a portion of the liquid suspended in the gas, wherein the expansive release cools the gas during the passage from a high-pressure state to a low-pressure state and saturates a portion of the liquid suspended in the cooled gas onto the condensation surface, and wherein the cooling results from a Joule-Thompson expansive cooling of the gas and a Ranque-Hilsch vortex tube cooling of the gas, and
a water collector for collecting the saturated portion of the liquid in suspension from the Livshits-Teichner generator.

32. The water-extraction system of claim 31, wherein the high-pressure gas further includes exhaust gas from an engine.

33. The water-extraction system of claim 32, wherein the engine is a diesel engine.

34. The water-extraction system of claim 32, wherein the saturated portion of the liquid in suspension includes unburned hydrocarbon particles present in the exhaust gas, and wherein the water collected includes the unburned hydrocarbon particles.

35. The water-extraction system of claim 34, wherein the system further comprises a fuel mix device connected to a fuel entry of the engine, the compressor, and a fuel tank, and wherein the water collected is mixed into the engine fuel at the fuel mix device.

36. The water-extraction system of claim 35, wherein the system further comprises a second fuel tank and a second Livshits-Teichner generator connected to the second fuel tank and the fuel mix device.

37. The water-extraction system of claim 31, wherein the high-pressure gas chamber of the Livshits-Teichner generator includes a circumferential cavity on the external portion of a ring and the low-pressure gas chamber is a cylindrical internal cavity in the center portion of the ring.

38. A method for the collection of a liquid suspended in a gas, comprising:
cooling a gas having a liquid in suspension below a saturation temperature of the liquid in the gas, wherein the cooling results from a Joule-Thompson gas expansive release at an opening and the creation of a Ranque-Hilsch vortex tube cooling in a cavity with the opening;
allowing for the cooled gas in the cavity to contact a surface to allow for the condensation of a saturated liquid at the surface; and
collecting the saturated liquid.

39. The method of claim 38, wherein the contact surface is selected from the group consisting of a cylindrical internal cavity, a fin, a surface of a wire, or a baffle.

40. The method of claim 38, wherein the saturated liquid is water and the saturated gas is compressed air.

41. The method of claim 38, wherein the saturated liquid is water with unburned hydrocarbon particles and the gas is a mixture of an exhaust gas from an engine and compressed air.

42. The method of claim 41, wherein the step of collecting the saturated water with unburned hydrocarbon particles is introduced into an engine producing the exhaust gas for improving overall fuel efficiency of the engine.

43. The method of claim 42, wherein the water with unburned hydrocarbon particles is introduced into the engine using a device for mixing and activation of fuel mix.
